(19) United States
(12) Patent Application Publication
(10) Pub. No.: US 2014/0359061 A1
(43) Pub. Date: Dec. 4, 2014

(54) Method and Apparatus for Automating Access Rights Creation and Control in Machine-to-Machine Systems

(71) Applicant: Telefonaktiebolaget L M Ericsson (publ), Stockholm (SE)

(72) Inventor: George Foti, Dollard des Ormeaux (CA)

(21) Appl. No.: 13/909,810

(22) Filed: Jun. 4, 2013

(51) Int. Cl. H04L 29/08

(52) U.S. Cl. CPC H04L 67/10
USPC 709/217

(57) ABSTRACT

In one aspect of the teachings herein, “inaugural” registrations by M2M applications are reported according to stored subscription information and the notification of an inaugural registration by a given application is used for the automatic determination of permissions for the application with respect to one or more resources stored in the M2M network. For example, a first application performs an inaugural registration with the Services Capability Layer (SCL) hosted at a first node and a corresponding inaugural registration notification is sent to the SCL at a second node, based on the second node being subscribed for notifications. Application-related identifiers in the inaugural registration notification are used at the second node to determine permissions for the first application with respect to a resource maintained at the second node. Further, ongoing registration and notification tracking prevent repeated notifications and minimize notification traffic between nodes, while still providing for automated setting of permissions.

### TECHNICAL FIELD

The present invention generally relates to Machine-to-Machine (M2M) systems, and particularly relates to automating the determination of resource permissions in such networks, responsive to detecting inaugural application registrations.

### BACKGROUND

The implementation of Machine-to-Machine (M2M) networks involves the creation and management of application resources, where a given resource may be owned or otherwise controlled by a given M2M application but shared with additional M2M applications. Consider, for example, an M2M network application running on a server in an M2M service provider's network, where the network application maintains a database of electric meter readings from a plurality of M2M device applications embedded or associated with a population of dispersed electric meters. Determining whether a given device application is permitted to update the database commonly is controlled according to permissions, e.g., access control lists, that in turn are provisioned or otherwise configured, for example, by the owner of the network application.

As a non-limiting example, access to resources in the M2M resource structure defined by the European Telecommunications Standards Institute (ETSI), requires that permissions be established in the form of access control lists. The interested reader may refer to Technical Specifications (TSs) published by ETSI regarding M2M architecture and functionality; namely, TS 102 921, “Machine-to-Machine communications (M2M); mIa, dIa and mId interfaces,” and TS 102 690, “Machine-to-Machine communications (M2M); Functional architecture.” As Machine-Type-Communications (MTC) become increasingly important and as the range and size of M2M networks increases, the creation and management of M2M resource permissions will become increasingly difficult to manage efficiently.

### SUMMARY

In one aspect of the teachings herein, “inaugural” registrations by M2M applications are reported according to stored subscription information and the notification of an inaugural registration by a given application is used for the automatic determination of permissions for the application with respect to one or more resources stored in the M2M network. For example, a first application performs an inaugural registration with the Services Capability Layer (SCL) hosted at a first node and a corresponding inaugural registration notification is sent to the SCL at a second, based on that second node being subscribed for notifications. Application-related identifiers in the inaugural registration notification are used at the second node to determine permissions for the first application with respect to a resource maintained at the second node. Further, ongoing registration and notification tracking prevent repeated notifications and minimize notification traffic between nodes, while still providing for automated setting of permissions.

In one embodiment, a method at a first node in an M2M network comprises receiving a subscription request from a second node in the M2M network, where the subscription request requests that inaugural registration notifications be sent from the first node to the second node. Correspondingly, the method includes storing subscription information corresponding to the subscription request, detecting that a registration by an application with an SCL hosted by the first node is an inaugural registration, and sending, in response to the detection, an inaugural registration notification to the second node, according to the subscription information. The method further includes recording the inaugural registration in registration information stored at the first node, for distinguishing a subsequent registration by the application with the SCL as a non-inaugural registration. Here, “recording” the inaugural registration may simply comprise logging an application identifier to indicate that that particular application has performed an inaugural registration at the node/SCL.

In an example embodiment, the first node includes a communication interface configured to communicate with one or more other nodes in the M2M network, including the second node. The first node further includes a processing circuit operatively associated with the communication interface and with a memory or other storage device. The processing circuit, which actually may comprise one or more digital processing circuits, e.g., one or more microprocessors and associated supporting circuitry, is configured to perform the above-described method, or variations thereof. The configuration of the processing circuit is achieved using fixed circuit, or is achieved programmatically, based on the execution of stored computer program instructions, or is achieved using a mix of fixed and programmed circuits.

In another embodiment, a method of automating access control in an M2M network comprises sending a subscription request from a second node in the M2M network to a first node in the M2M network, requesting notification of inaugural registrations by M2M applications with an SCL hosted by the first node, and receiving at the second node an inaugural registration notification from the first node in accordance with the subscription request, for a first application that conducted an inaugural registration with the SCL hosted at the first node. The method further comprises determining permissions information at the second node for the first application with respect to a resource maintained at the second node by or for a second application that is registered at the second node, for controlling access to the resource by the first application.

Like the above-described first node, the second node comprises a communication interface and a processing circuit operatively associated with the communication interface and memory. The processing circuit is configured to carry out the second-node method, or variations thereof. The configuration of the processing circuit is achieved using fixed circuit, or is achieved programmatically, based on the execution of stored computer program instructions, or is achieved using a mix of fixed and programmed circuits.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of one embodiment of a M2M network, including one or more nodes that are configured according to the teachings disclosed herein.

FIG. 2 is a block diagram of one embodiment of an example node from the M2M network introduced in FIG. 1.

FIG. 3 is a block diagram of one embodiment of functional processing details, such as may be implemented in the example node of FIG. 2.

FIG. 4 is a logic flow diagram of one embodiment of a method of providing inaugural registration notifications in accordance with a notification subscription.

FIG. 5 is a logic flow diagram of one embodiment of a method of subscribing to inaugural registration notifications and automatically setting access rights responsive to such notifications.

FIG. 6 is a block diagram of another embodiment of an M2M network, including one or more nodes configured according to the teachings herein.

FIG. 7 is a block diagram of yet another embodiment of an M2M network, including one or more nodes configured according to the teachings herein.

FIGS. 8A-8C and 9A-9C illustrate example signaling diagrams for various embodiments of the inaugural registration notification signaling as taught herein, e.g., for use in automatically creating or controlling access rights by M2M applications registering in a M2M network.

### DETAILED DESCRIPTION

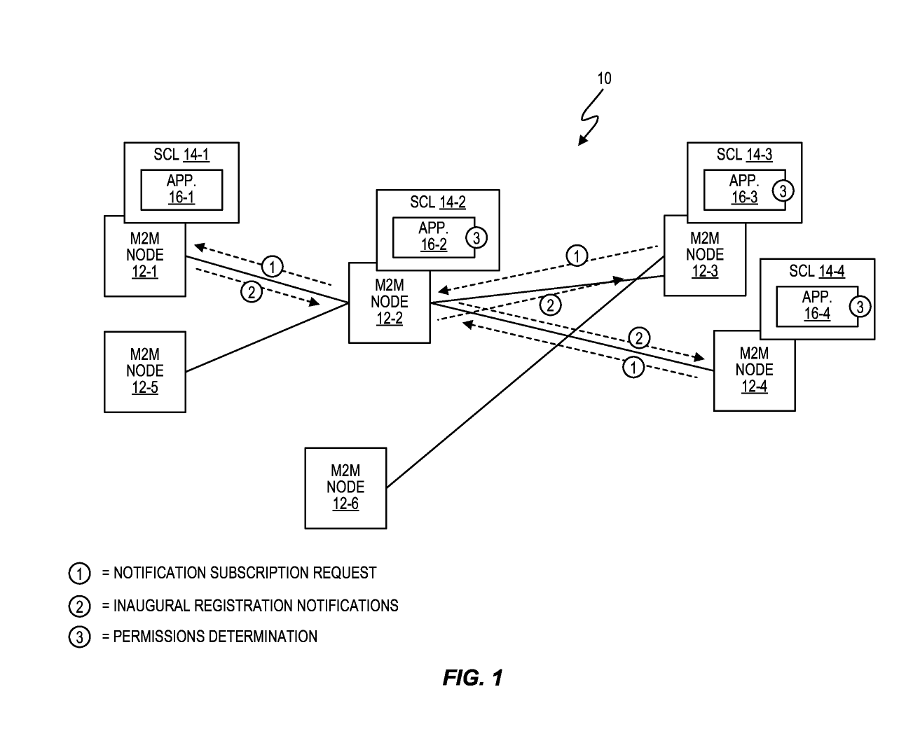

FIG. 1 illustrates an example embodiment of a Machine-to-Machine (M2M) network 10, which includes a number of M2M nodes 12 (hereafter “nodes”). It should be noted that the nodes 12 are not necessarily directly connected together. For example, some of the nodes 12 may connect with access networks, which are not shown, to gain a communicative connection to other nodes 12. For example, the node 12-1 may be an M2M device, such as may be functionally implemented at a remote site, and the M2M device may include or be associated with a cellular modem or other wireless transceiver that it uses to connect with an access network that provides IP connectivity with one or more other nodes 12 in the M2M network 10.

Further, while not shown for all nodes 12, each node 12 generally hosts or otherwise implements a Services Capability Layer or SCL, 14. Note that in some cases some nodes, known as hidden nodes, will not have their own SCL and applications in such hidden nodes access an SCL hosted in another node. For a given node 12 and its corresponding SCL 14, any number of M2M applications 16 may register with the SCL 14, and may create or use resources (not explicitly shown) within that SCL 14, and may access resources stored in the SCLs 14 at other nodes 12, e.g., by making requests through their respective SCLs 14, with which they are registered. In this regard, each SCL 14 represents an abstraction layer of the M2M software, where common functionalities are implemented to serve any number of M2M applications 16 registered at the node 12. The SCL 14 provides, for example, a set of Application Programming Interfaces or APIs, which expose M2M service capabilities to the M2M applications registered at the node 12. As a non-limiting example context, the interested reader may refer to Technical Specifications (TSs) published by the European Telecommunications Standards Institute regarding M2M architecture and functionality; namely, TS 102 921, “Machine-to-Machine communications (M2M); mIa, dIa and mId interfaces,” and TS 102 690, “Machine-to-Machine communications (M2M); Functional architecture.”

Further, while “node 12,” “SCL 14” and “application 16” are used in a generic sense herein, for both singular and plural references to nodes, SCLs and applications within the example M2M network 10, not all nodes 12 are necessarily of the same type, e.g., one or more nodes 12 may be M2M devices, one or more nodes 12 may be M2M Gateways (GWs), and one or more nodes 12 may be M2M servers, e.g., located within an M2M Service Provider's network. Correspondingly, the SCLs 14 in those nodes 12 that are M2M devices are Device SCLs (D-SCLs), the SCLs 14 in those nodes 12 that are M2M GWs are Gateway SCLs (G-SCLs), and the SCLs 14 in those nodes 12 that are M2M servers are Network SCLs (N-SCLs). Likewise, M2M applications 16 running on nodes 12 that are M2M devices comprise device applications, M2M applications 16 running on nodes 12 that are M2M GWs are GW applications, and M2M applications 16 running on nodes 12 that are M2M servers are network applications. For nodes 12 that are M2M GWs, M2M applications 16 can be also resident on M2M devices that are “hidden” behind the M2M GW, where such applications 16 use the SCL 14 of the M2M GW is a fashion identical to that of applications 16 running directly on the M2M GW.

When suffixes are not needed for clarity, the reference number 12 is used to refer to a given M2M node or nodes in the network 10, the reference number 14 is used to refer to a given SCL or SCLs, and the reference number 16 is used to refer to a given application or applications registered in (or registering with) such SCL(s). In instances where suffixes aid clarity, they are used to distinguish between individual ones among two or more nodes 12, e.g., 12-1, 12-2, and so on. The same suffixing scheme is used for distinguishing between SCLs 14, e.g., SCL 14-1 in node 12-1, SCL 14-2 in node 12-2, and so on. The same approach is used for distinguishing between applications 16, e.g., a first application 16-1 registered with (or registering in) the SCL 14-1 of the node 12-1, a second application 16-2 registered with (or registering in) the SCL 14-2 of the node 12-2, and so on.

While there may be multiple M2M messages and actions flowing between various ones of the nodes 12, and with various corresponding actions taken by or between such nodes 12, FIG. 1 uses the numbers “1” and “2” to denote two particular types of messages, with “1” denoting a notification subscription request and “2” denoting an inaugural registration notification. Here, an “inaugural registration” by a given application 16 with an SCL 14 should be understood as the initial or first-time registration by the application 16 with respect to the SCL 14. Subsequent registrations, such as after power-cycling or disconnect/reconnect events, etc., are non-inaugural registrations.

Continuing with the diagram, the number “3” is used to denote the action of determining permissions (access control rights) for a given application with respect to a resource, such as stored data or other such information. It should be understood in this context, that the singular reference to a “resource” does not preclude the presence of more than one resource and the act of determining permissions with respect to a resource may be understood as encompassing the possibility of determining permissions with respect to more than one resource and that the permissions determined with respect to a given resource are not necessarily the same as the permissions determined with respect to another given resource, for the same application 16.

Accordingly, FIG. 1 can be understood by way of non-limiting example as illustrating a first node 12-1 receiving a subscription request from a second node 12-2, requesting that the first node 12-1 send inaugural registration notifications to the second node 12-2, responsive to the first node 12-1 detecting inaugural—i.e., first-time, initial registrations—of applications 16 at the first node 12-1. These communications and the logic driving them are implemented, for example, in the SCLs 14-1 and 14-2, which are hosted at the first and second nodes 12-1 and 12-2, respectively. A similar arrangement is shown between the nodes 12-2 and 12-3, and between the nodes 12-2 and 12-4, and it should be appreciated that a given node 12 may be both a subscriber for notifications from another node 12, as well as a provider of notifications to another node 12. It should also be understood that one node 12 may have more than one other node 12 subscribed to it, and that it may subscribe to more than one other node 12.

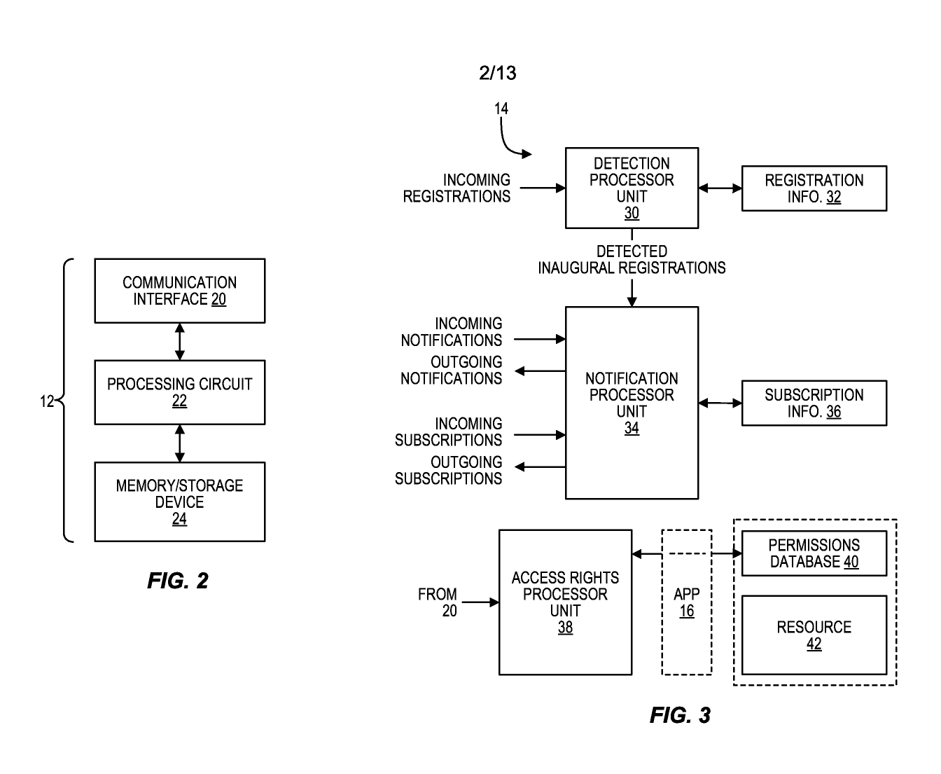

FIG. 2 illustrates an example but non-limiting arrangement a given node 12 in the M2M network 10. Assume for the moment that the node 12 plays the role of a notifier, meaning that it notifies one or more other nodes 12 of inaugural registrations by applications 16 with the SCL 14 of the node 12. With this assumption, the node 12 may be regarded as a first node 12-1 and it will be assumed that a second node 12-2 has or will subscribe for notifications from the first node 12-1.

In this context, the first node 12-1 comprises a communication interface 20 configured to communicate with one or more other nodes 12 in the M2M network 10, including the aforementioned second node 12-2. The first node 12-1 further includes a processing circuit 22 operatively associated with the communication interface 20 and with a memory or other storage device 24. The communication interface 20 may comprise one or more physical interface circuits, wired and/or wireless, such as Ethernet and/or cellular radio, and the memory or other storage device 24 comprises one or more computer-readable mediums, such as working memory like SRAM and non-volatile memory such as FLASH, solid-state disk, magnetic disk, etc. Of course, these implementation particulars are not germane and should be considered only as non-limiting examples. In any case, the nature of the communication interface 20, the processing circuit 22 and the memory or other storage device 24 will depend on the particular type and features of the node 12-1, and typically be different in dependence on what role the node 12-1 plays within the M2M network 10.

In the context of the above-described role, the processing circuit 22 is configured to receive a subscription request from the second node 12-2, where the subscription request requesting that inaugural registration notifications be sent from the first node 12-1 to the second node 12-2, e.g., for applications 16 performing inaugural registrations with the SCL 14 hosted at the first node 12-1. The processing circuit 22 is further configured to store subscription information corresponding to the subscription request, and to detect that a registration by an application 16-1 with the SCL 14-1 hosted by the first node 12-1 is an inaugural registration. Further, the processing circuit 22 is configured to send, in response to the detection of the inaugural registration, an inaugural registration notification to the second node 12-2, according to the subscription information and to record the inaugural registration in registration information stored at the first node, for distinguishing a subsequent registration by the application 16-1 with the SCL 14-1 as a non-inaugural registration. That is, “remembering” at the first node 12-1 which applications 16 have performed an inaugural registration with the SCL 14-1 at the first node 12-1 prevents the processing circuit 22 from mistaking a subsequent registration by the same application 16 as an inaugural registration.

The processing circuit 22 in one or more embodiments is also configured to record the inaugural registration notification in the subscription information, to prevent duplicate inaugural registration notifications from being sent to the second node 12-2 for the same inaugural registration. That is, the first node 12-1 remembers to which subscribers it has sent a given inaugural registration notification, to prevent sending more than one inaugural registration notification to the same subscriber for any given application 16 unless, for example, the node 12-1 is responding to an explicit request for past, previously reported registrations.

In the same or another embodiment, the processing circuit 22 is configured to send the inaugural registration notification to the second node 12-2 by sending one or more application-related identifiers, including at least one of: a name of the application 16-1, an identifier of the application 16-1, a uniform resource locator (URL) of the application 16-1, and an identifier of the SCL 14-1 hosted by the first node 12-1. And, as noted, in one or more embodiments, the processing circuit 22 is configured to send the inaugural registration notification to as many other nodes 12 in the M2M network 10 as have subscribed to the first node 12-1 for inaugural registration notifications. In that regard, the processing circuit 22 is configured to identify the other nodes 12 in the M2M network 10 to which the first node 12-1 should send inaugural registration notifications, based on recording corresponding subscription requests from each of the other nodes 12 in the subscription information.

In at least one example configuration, the processing circuit 22 is configured to maintain state information at the first node 12-1. The state information comprises indicators indicating that inaugural registrations have been detected at the first node 12-1 for given applications 16. The state information further comprises indicators indicating that inaugural registration notifications for a given application 16 have been sent to given other nodes 12, in accordance with the subscription information stored for the given other nodes 12. In this manner, the first node 12-1 detects and report inaugural notifications, but avoids duplicative reporting, based on maintaining state information regarding which applications 16 have been detected as performing inaugural registrations and which subscribers have been notified of the inaugural registrations.

Such functionality can be implemented at essentially any “level” of the M2M network 10 and indeed can be implemented at multiple levels. Thus, the first node 12-1 may be any one of an M2M network server hosting an N-SCL, an M2M GW hosting a G-SCL, or an M2M device hosting a D-SCL. An M2M device node may report inaugural registrations to one or more M2M GWs, for example, and/or to one or more M2M network servers, while an M2M GW may report inaugural registrations to one or more M2M devices and/or one or more M2M network servers.

FIG. 3 illustrates circuitry and/or processing logic that may be functionally realized via the processing circuit 22 and memory or other storage device 24 in a node 12. Notably, FIG. 3 illustrates functionality associated with a node 12 acting as a notifier and acting as a subscriber, but it is also contemplated herein that a given node 12 has one or the other capability, but not both. Again, a “notifier” is a node 12 that is configured to detect inaugural registration notifications and report them according to stored subscription information, while a “subscriber” is a node 12 that is configured to subscribe for such notifications, and to perform certain processing in response to receiving such notifications.

Thus, in FIG. 3, one sees a detection processing unit 30 that maintains registration information 32, a notification processing unit 34 that maintains subscription information 36, and an access rights processor unit 38 that maintains a permissions database 40 that defines access rights for given applications 16 with respect to a resource 42, which may be a data store or other structure within the host SCL 14. A “notifier” would have at least the detection processor unit 30 and at least a partial implementation of the notification processor unit 34, while a “subscriber” would have at least a partial implementation of the notification processor unit 34 and generally would have the access rights processor unit 38. Here, “unit” is used for labeling these processing elements merely to emphasize that they can be programmatically implemented as functional elements within general-purpose processing circuitry.

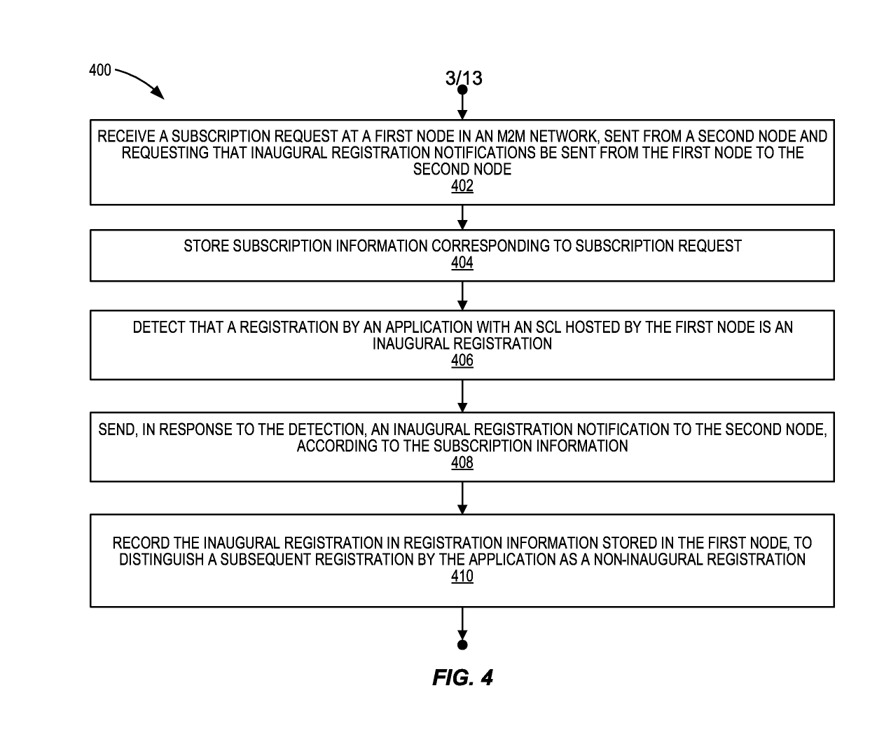

FIG. 4 illustrates a method 400 that can be understood as one example of the processing operations associated with a first node 12-1 operating in the notifier role. The method 400 includes receiving (Block 402) a subscription request from a second node 12-2 in the M2M network 10, requesting that inaugural registration notifications be sent from the first node 12-1 to the second node 12-2 and storing (Block 404) subscription information 36 (see FIG. 3) corresponding to the subscription request.

The method 400 further includes detecting (Block 406) that a registration by an application 16-1 with an SCL 14-1 hosted by the first node 12-1 is an inaugural registration and sending (Block 408), in response to the detection, an inaugural registration notification to the second node 12-2, according to the subscription information 36. Here, sending the inaugural registration notification “according to” the subscription information 36 can be understood as any one or more of: checking that the second node 12-2 is subscribed for such notifications, checking whether the same notification has already been sent, verifying or obtaining a network address or other identifier used to form the notification or to direct its sending, etc.

The method 400 further includes recording (Block 410) the inaugural registration in registration information 32 (see FIG. 3) stored at the first node 12-1, for distinguishing a subsequent registration by the application 16-1 with the SCL 14-1 as a non-inaugural registration. This operation, as explained before, can be understood as the first node 12-1 remembering the inaugural registration for the involved application 16-1, so that subsequent registrations at the SCL 14-1 by the same application 16-1 are recognized as non-inaugural registrations. The method 400 as performed by the first node 12-1 in one or more embodiments also includes the step of updating or otherwise storing state information indicating to which entities (e.g., to which applications 16 and/or nodes 12) the inaugural notification has been sent, to avoid sending duplicate notifications to those entities.

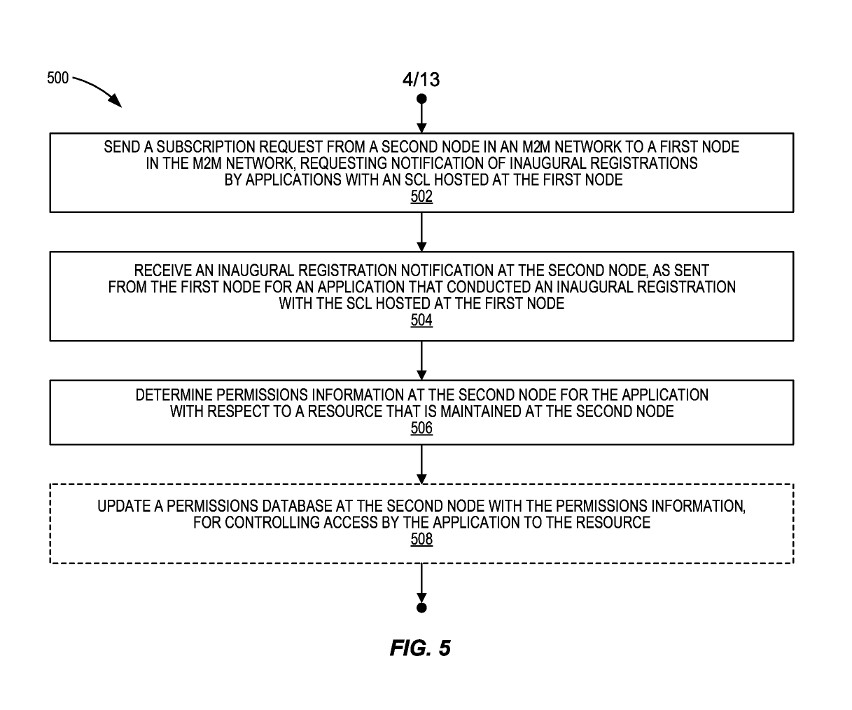

FIG. 5 illustrates a method 500 that can be understood as an example embodiment of processing operations for a node 12 acting in the subscriber role. The method 500 automates access control in the M2M network 10 and includes sending (Block 502) a subscription request from a second node 12-2 in the M2M network 10 to a first node 12-1 in the M2M network 10, requesting notification of inaugural registrations by M2M applications 16 with the SCL 14-1 hosted by the first node 12-1. The method 500 further includes receiving (Block 504) at the second node 12-2 an inaugural registration notification from the first node 12-1 in accordance with the subscription request, for a first application 16-1 that conducted an inaugural registration with the SCL 14-1 hosted at the first node 12-1.

Still further, the method 500 includes determining (Block 506) permissions information at the second node 12-2 for the first application 16-1 with respect to a resource 42 (as shown in FIG. 3) maintained at the second node 12-2 by or for a second application 16-2 that is registered at the second node 12-2, for controlling access to the resource 42 by the first application 16-1. For example, at some time after the inaugural registration, the application 16-1 may request access to the resource, e.g., via the SCL 14-1, and that request will be handled based on the permissions information that was automatically determined for the application 16-1 in conjunction with its inaugural registration. In this regard, the method 500 may further include the step of updating (Block 508) a permissions database 40 that is in or accessible to the SCL 14-2 of the second node 12-2, with the permissions information stored for the registering application 16-1, for subsequent use in controlling access to the resource 42 by the application 16-1.

As noted before, the application-related identifiers indicated in the inaugural registration notification sent for the application 16-1 includes one or more of the following items: a name of the first application 16-1, an identifier of the first application 16-1, a uniform resource locator (URL) of the first application 16-1, and an identifier of the SCL 14-1 hosted at the first node 12-1. The identifier(s) allow the SCL 14-2 and/or the owner of the resource 42 to determine the permissions information for the application 16-1 with respect to the resource 42, without need for manual provisioning. In this regard, it will be understood that the permission decisions can be made by the SCL 14-2, at least where the resource owner has delegated that authority. If the SCL 14-2 does not have that authority, in one embodiment, it communicates the application-related identifier(s) to the resource owner, e.g., another M2M application, and receives the permission information back from the resource owner for updating the permissions database 40. In still other embodiments, the SCL 14-2 passes along the application-related identifiers to the resource owner, and the resource owner updates the permissions database 40.

The method 500 can be implemented in the node 12 shown in FIG. 2, via proper configuration of the processing circuit 22 of the node 12. Such a configuration can coexist with the notifier configuration embodied in the method 400 of FIG. 4, or can be implemented without also implementing the notifier configuration. In particular, the processing circuit 22 is, with respect to implementation of the method 500, configured to: send a subscription request to a first node 12-1, requesting notification of inaugural registrations by M2M applications 16 with an SCL 14-1 hosted by the first node 12-1; receive an inaugural registration notification from the first node 12-1 in accordance with the subscription request, for a first application 16-1 that conducted an inaugural registration with the SCL 14-1 hosted at the first node 12-1; and determine permissions information at the second node 12-2 for the first application 16-1 with respect to a resource 42 maintained at the second node 12-2 by or for a second application 16-2 that is registered at the second node 12-2, for controlling access to the resource 42 by the first application 16-1.

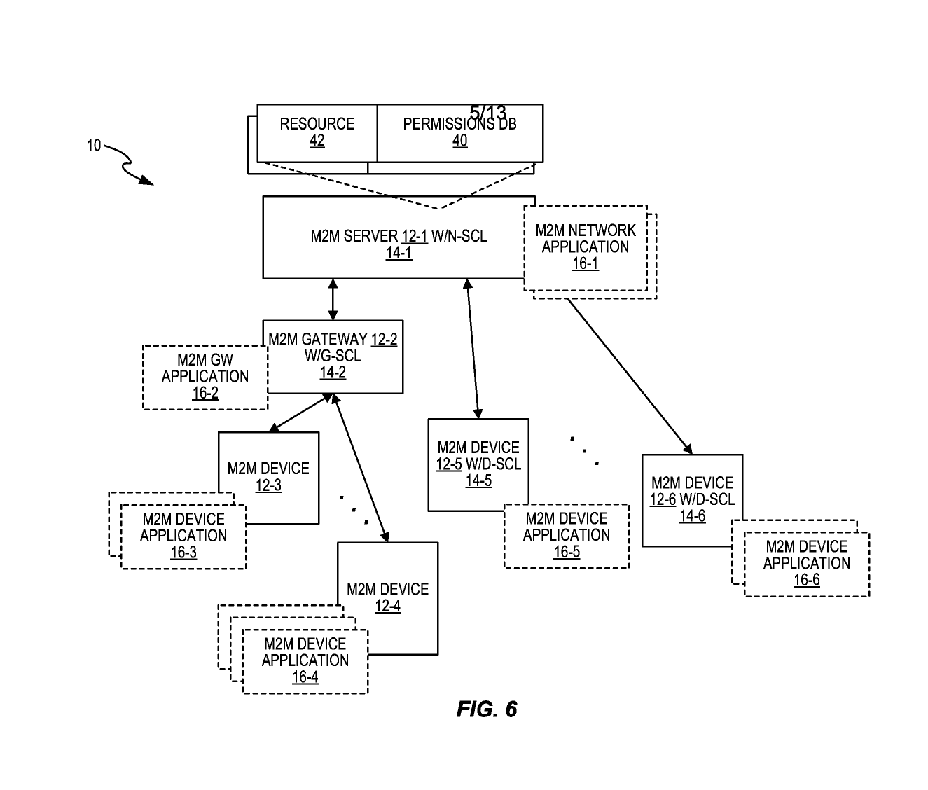

FIG. 6 illustrates another example M2M network 10, wherein a first node 12-1 is an M2M network server hosting a network SCL 14-1, in which one or more network applications 16-1 are registered. A resource 42 is hosted at the first node 12-1 and access to the resource 42 is controlled according to permissions information stored in a corresponding permissions database 40. An M2M GW operates as a second node 12-2 in the M2M network 10, and it hosts a GW SCL 14-2 and one or more M2M gateway applications 16-2. There may be one or more M2M devices hidden behind the node 12-2 operating as an M2M GW, and the diagram depicts two such hidden M2M devices as nodes 12-3 and 12-4. The respective device applications 16-3 and 16-4 use the GW SCL 14-2 in a fashion identical to that of the GW applications 16-2 running on the node 12-2.

Still further, one or more M2M devices may connect directly (with or without having to use an access network link) to the first node 12-1, with nodes 12-5 and 12-6 shown in that role. As compared to nodes 12 hidden behind the node 12-2 operating as an M2M GW, the nodes 12-5 and 12-6 are directly visible to the N-SCL 14-1 hosted at the node 12-1. In that regard, the node 12-5 hosts an M2M device SCL 14-5 and runs one or more M2M device applications 16-5. Likewise, the node 12-6 hosts an M2M device SCL 14-6 and runs one or more M2M applications 16-6.

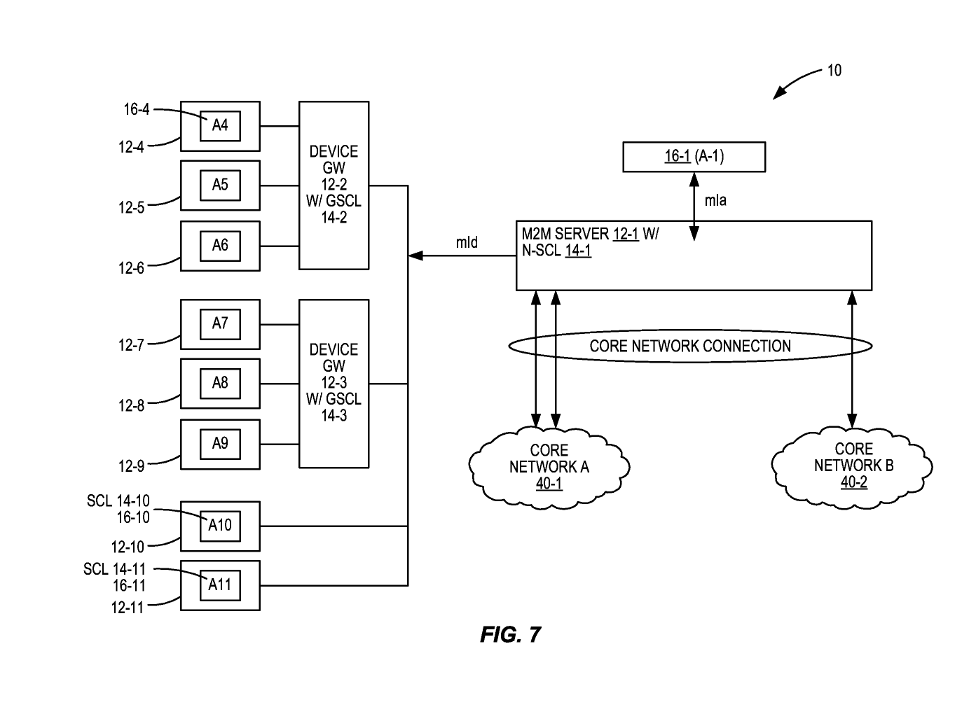

FIG. 7 illustrates a similar scenario, but also illustrates that one or more core networks 40 may be communicatively linked to the first node 12-1 operating as an M2M network server, where core networks 40-1 and 40-2 are shown by way of non-limiting example. The core networks 40 are associated with wireless communication networks, e.g., Public Land Mobile Networks (PLMNs) that provide access to the M2M server via their associated Radio Access Networks or RANs. Again in FIG. 7, one sees that M2M devices may be hidden behind one or more M2M GWs, e.g., nodes 12-4 through 12-9 are M2M devices hidden behind nodes 12-2 and 12-3, each of which operates as an M2M GW. As such, the applications 16-4 through 16-9 running on respective ones of the nodes 12-4 through 12-9 use the SCL 14-2 or 14-3 of a corresponding one of the nodes 12-2 or 12-3, rather than such nodes hosting their own respective SCLs. In contrast, the nodes 12-10 and 12-11 connect directly with the node 12-1 and host their own respective SCLs 14-10 and 14-11. As such, the nodes 12-10 and 12-11 are not hidden from the node 12-1 and instead are directly visible.

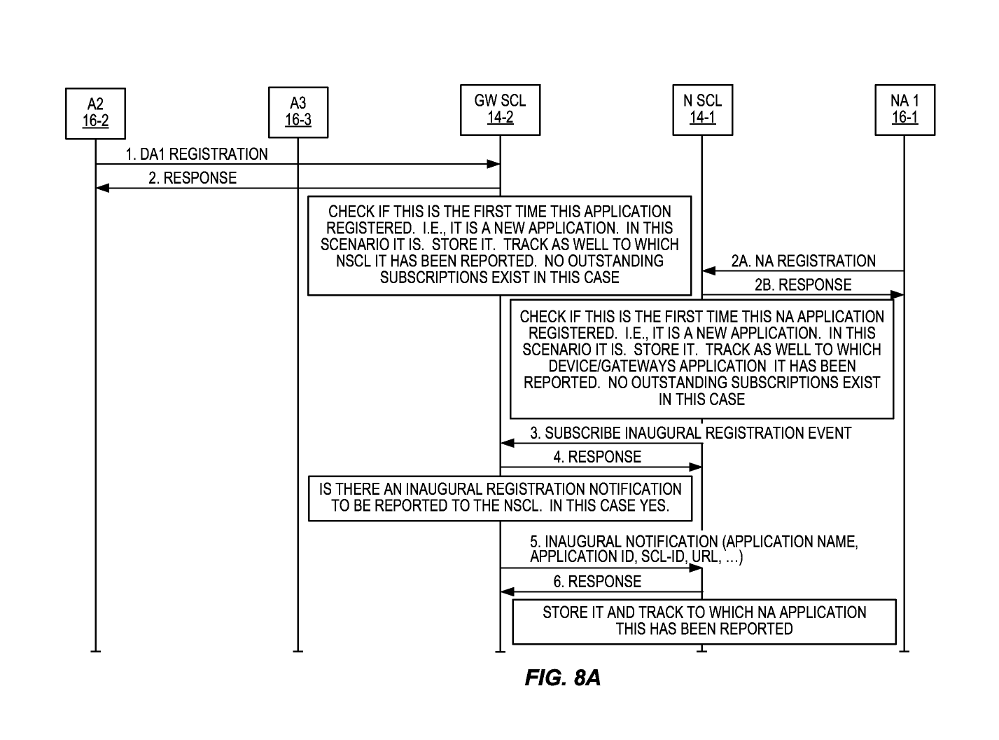

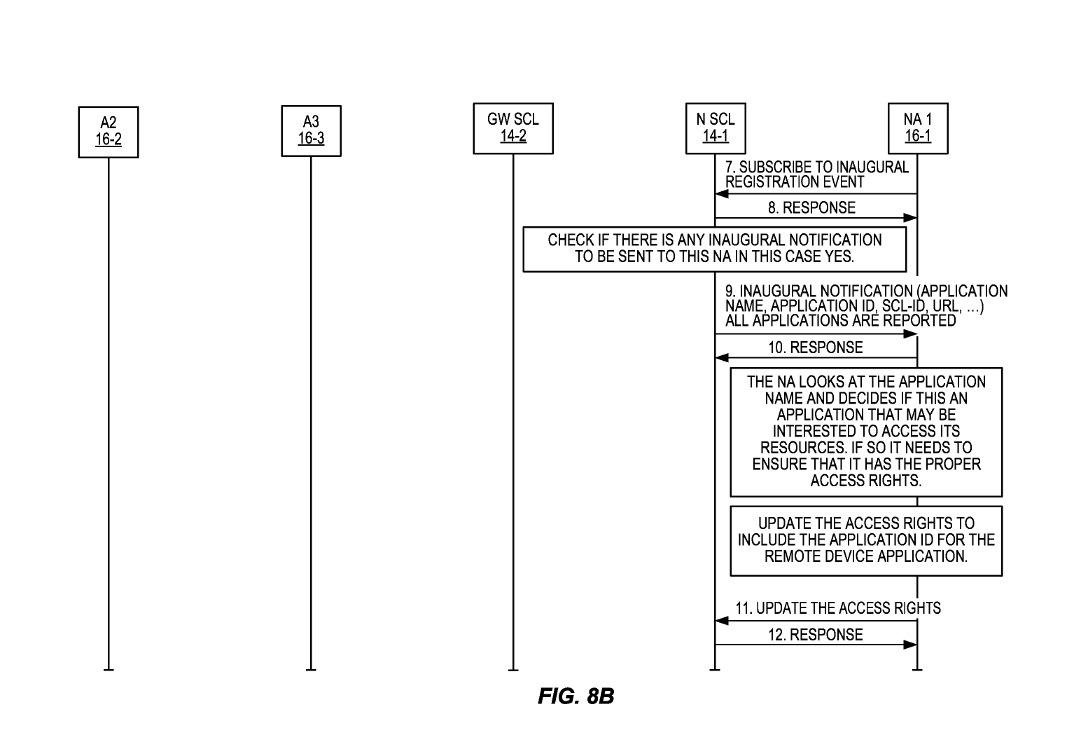

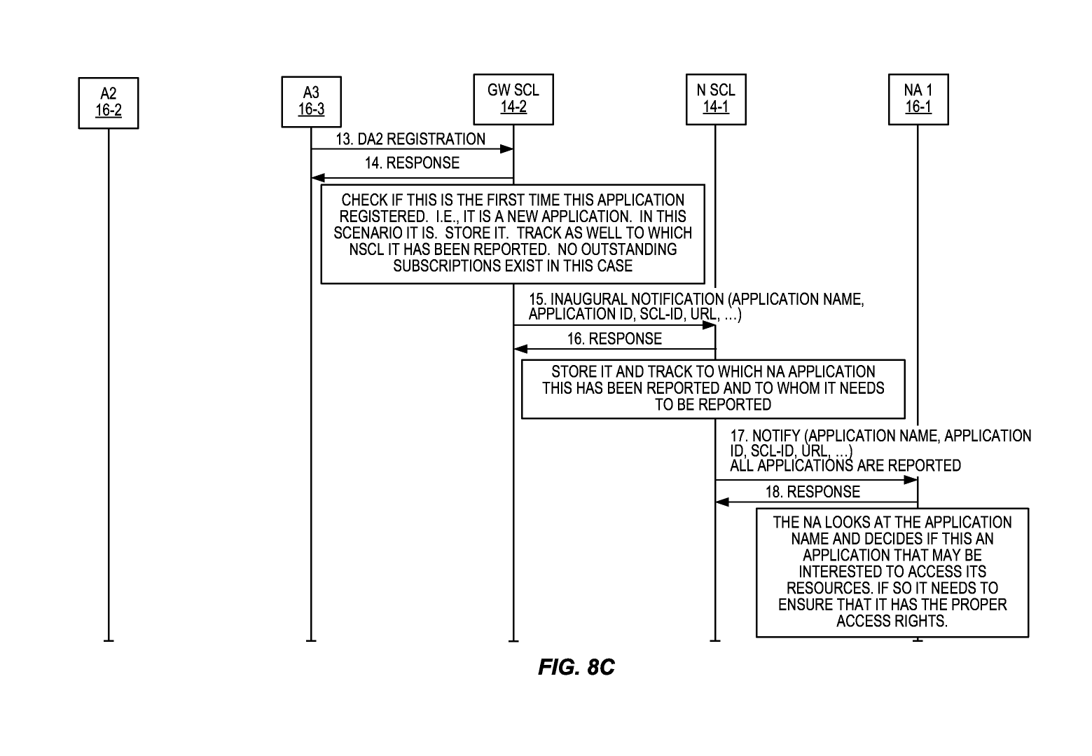

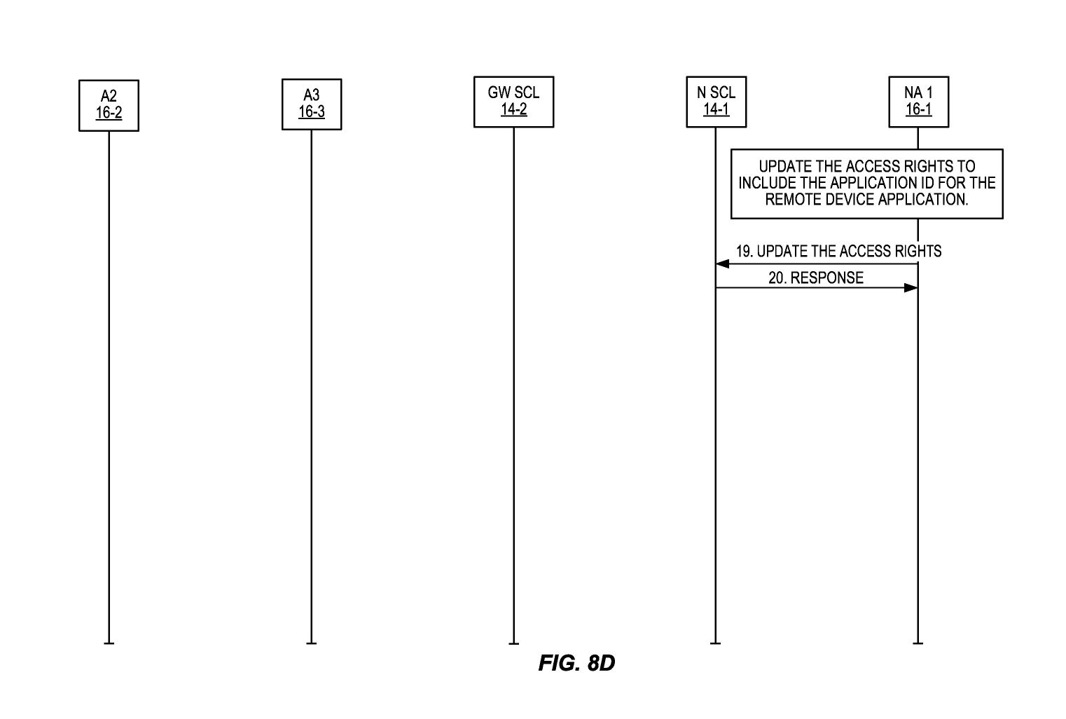

FIGS. 8A-8C illustrate example signaling contemplated in one or more embodiments herein. A first SCL 14-1 operates as an M2M network SCL and is hosted at a corresponding node 12, which operates as an M2M network server but is not shown explicitly in the diagram. A second SCL 14 operates as an M2M GW SCL and is hosted at another corresponding node 12 in the M2M network, which is also not shown. A first application 16-1 is configured as an M2M network application and it interacts with the first SCL 14-1. Second and third applications 16-2 and 16-3 operate as M2M gateway or (hidden) device applications and interact with the second SCL 14-2.

At Step 1, the application 16-2 registers with the SCL 14-2, which provides a registration response to the application 16-2, and which checks whether the registration is an inaugural registration. For this example, one may assume that the registration is an inaugural registration and the SCL 14-2 therefore stores/tracks that registration. However, there are as of yet, no outstanding subscriptions recorded at the SCL 14-2 for which the inaugural registration should be reported.

Likewise, the application 16-1 performs an inaugural registration with the SCL 14-1 and receives a corresponding response at Steps 2a and 2b, respectively. The SCL 14-1 detects the registration as being an inaugural registration but it does not currently have any outstanding subscriptions recorded and thus does not yet report the inaugural registration of the application 16-1.

At Step 3, the SCL 14-1 subscribes to the SCL 14-2 for inaugural registration notifications, and receives a subscription request response in return at Step 4, e.g., an acknowledgement. Now having an active subscription recorded, the SCL 14-2 determines that it previously detected an inaugural registration by the application 16-2 and further determines that it has not previously reported that event to the SCL 14-1. Thus, at Step 5 it sends an inaugural registration notification to the SCL 14-1 and receives a return response at Step 6, e.g., an acknowledgement. (In general, the request/response protocol can be made robust to include ACK/NACK and retry protocols.)

The SCL 14-1 stores or otherwise records that it has sent the inaugural registration notification to the SCL 14-2 and in a general sense tracks for which outstanding subscriptions it has reported any given inaugural registration. In that manner, the SCL 14-1 avoids mistaking subsequent registrations by a given application 16 as being inaugural registrations, and avoids mistakenly sending more than one inaugural registration notification for the same inaugural registration to the same subscribing entity (where a subscribing entity is either an application 16 or another SCL 14 that has subscribed for such notifications).

At this point in the flow, no other SCLs 14/applications 16 have sent subscription requests to the SCL 14-1, thus it has no outstanding subscriptions for which it should forward the inaugural registration notification received from the SCL 14-2. However, at Step 7, the application 16-1 subscribes to the SCL 14-1 for inaugural registration notifications, and the SCL 14-1 sends a response at Step 8. If the application 16-1 is hosted within the SCL 14-1, such signaling may be internal to the node 12 hosting the SCL 14-1 and it should be understood that there may be at least two types of entities involved in subscriptions and notifications—i.e., applications 16 and SCLs 14.

Namely, one SCL 14 may subscribe to another SCL 14, and one SCL 14 may send notifications to another SCL 14. Individual applications 16 also can subscribe to an SCL 14 for notifications. In one example, an SCL 14-2 has subscribed to an SCL 14-1 and another SCL 14-3 has subscribed to the SCL 14-2. Thus, the SCL 14-2 is a subscriber with respect to the SCL 14-1 and a notifier with respect to the SCL 14-3. Correspondingly, a notification sent from the SCL 14-1 to the SCL 14-2 causes that the SCL 14-2 to generate corresponding notification for the SCL 14-3, because it too subscribed to the SCL 14-2.

In at least one implementation of this approach, subscription and notification messages sent between nodes 12 generally are managed by the SCLs 14 hosted at the respective nodes 12, but a given SCL 14 may forward notifications received from another node 12/SCL 14 to applications 16 registered with the given SCL 14, if they also subscribe to receive such a notification. Thus, in the context of this disclosure and unless otherwise noted, the description of one node 12 subscribing to another node 12, or sending notifications to another node 12, may be understood as being communications managed by the SCLs 14 at those nodes.

However, this scheme contemplates restrictions on which entities can subscribe to which other entities for inaugural registration notifications. In particular, an N-SCL can subscribe to any gateway or device and a gateway or a device can subscribe to any NSCL. However, a gateway cannot subscribe to a device and a device cannot subscribe to a gateway. Nonetheless, such entities can learn about inaugural registrations even where they are not direct subscribers to the SCL in which the registrations occur, by virtue of their ability to subscribe to the involved N-SCL, because the N-SCL can subscribe to anything.

After Step 8, the SCL 14-1 checks whether there are any outstanding inaugural registration notifications that have not been reported to the application 16-1. Here, because the application 16-1 subscribed after the SCL 14-1 received the inaugural registration notification from the SCL 14-2 for the application 16-2, the answer is “yes” and the signal flow continues at Step 9 with the SCL 14-1 sending a corresponding inaugural registration notification to the application 16-1. At Step 10, the SCL 14-1 receives an acknowledgment or other response from the application 16-1, and it logs or otherwise remembers that it has successfully notified the application 16-1 of this particular inaugural registration, so as not to inadvertently repeat the notification, e.g., after power cycling or other restart.

Now, in the illustrated signal flow, the application 16-1 uses the inaugural registration notification sent from the SCL 14-1 for the inaugural registration of the application 16-2, to determine whether or to what extent the application 16-2 should be granted access rights to a resource 42 that is owned or otherwise controlled by the application 16-1. The resource 42 is, for example, maintained in the SCL 14-1.

The access rights determination may be as simple as determining whether the application 16-2 is permitted to read or write data with respect to the resource 42. Of course, access rights determination can be more sophisticated, e.g., determining whether the application 16-2 is permitted to see data written into the resource 42 by other applications, etc. In any case, the application 16-1 uses the information in the inaugural registration notification it received from the SCL 14-1 to identify the application 16-2 and/or to perform other authentication and subscription determinations, and correspondingly updates the access rights at Step 11. For example, at Step 11 it sends access rights, also referred to as permissions information, to the SCL 14-1. At Step 12, the SCL 14-1 acknowledges receipt of the permissions information and, for example, uses the received permissions information to update a permissions database 40.

Steps 13-20 show similar processing except with respect to a third application 16-3, which is hosted by the same or a different SCL 14/node 12 as hosts the second application 16-2. What is interesting from the signal flow perspective, however, is that at the time the application 16-3 performs its inaugural registration with the SCL 14-2, there is an outstanding subscription at the SCL 14-2, from the SCL 14-1. Thus, the inaugural registration automatically generates the notification and response at Steps 15 and 16. Likewise, there is an outstanding subscription at the SCL 14-1, from the application 16-1. Therefore, the inaugural registration notification received at the SCL 14-1 from the SCL 14-2 for the application 16-3 is propagated or forwarded to the application 16-1. Of course, the same checks and logging are in place at both SCLs 14-2 and 14-1, so that repeated notifications are not sent for the same application 16 to the same subscribing SCL 14.

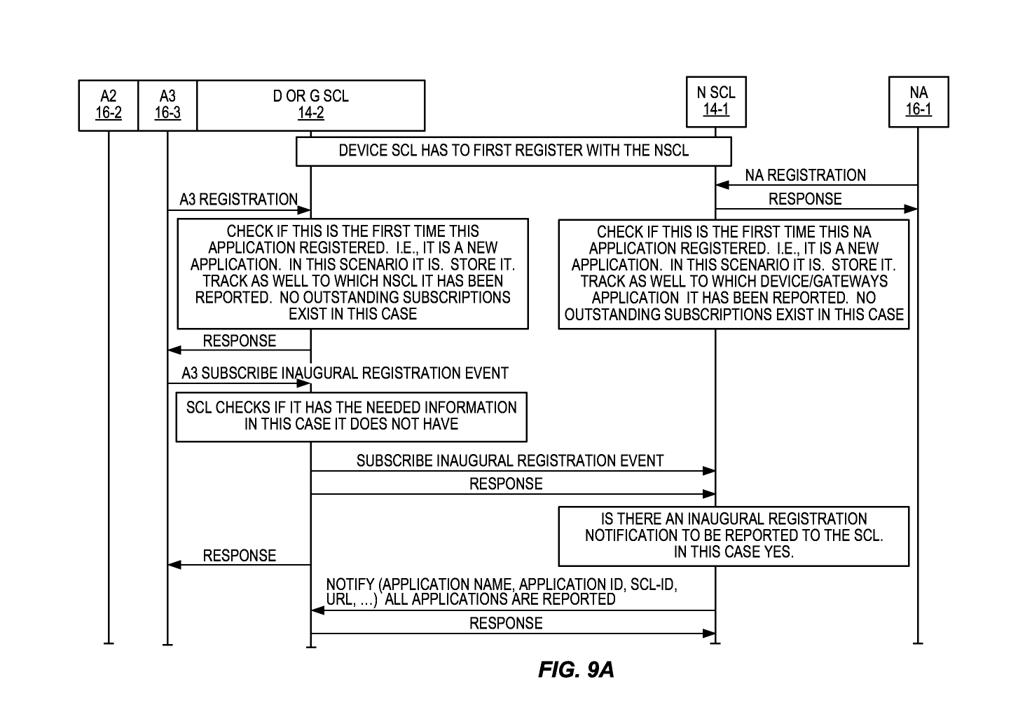

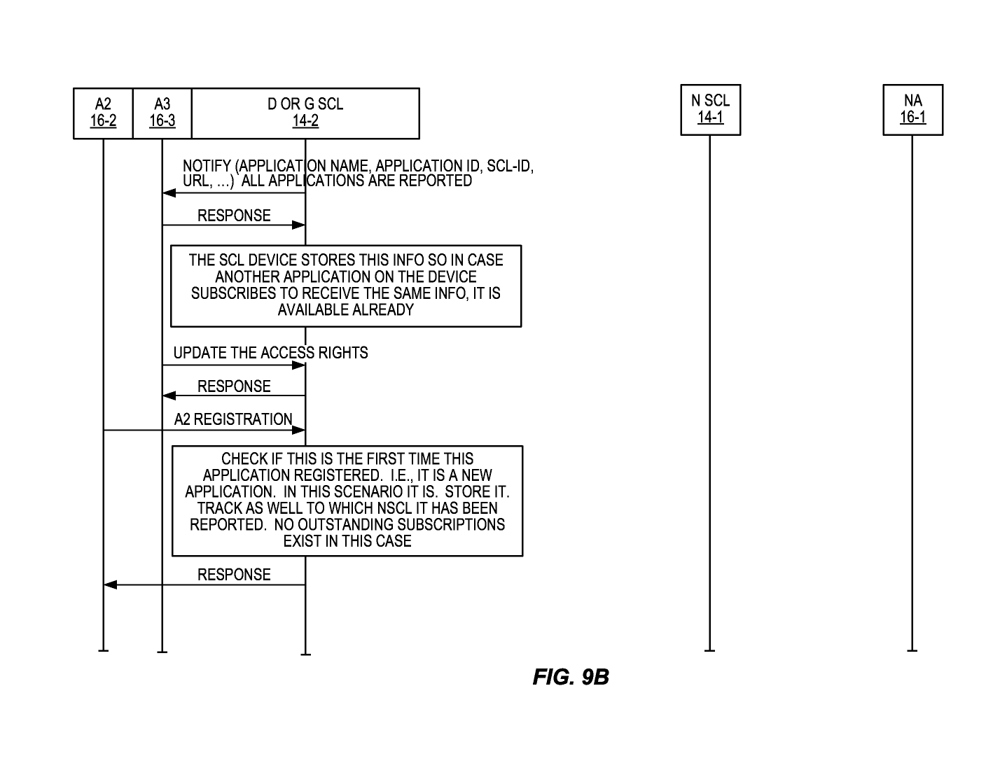

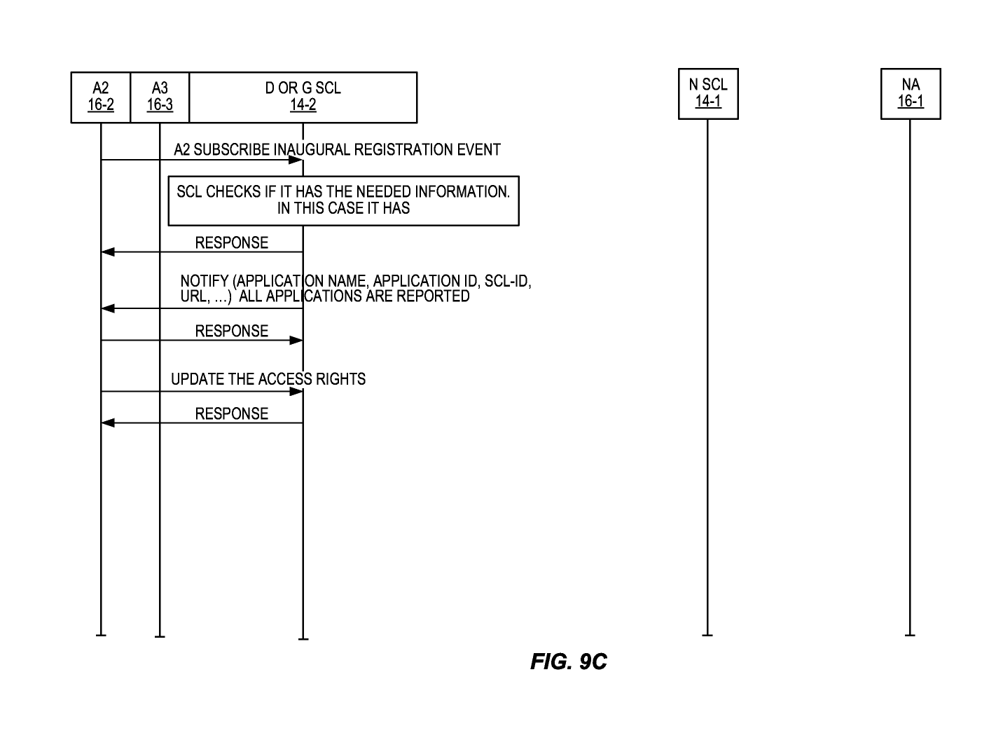

FIGS. 9A-9C illustrate similar functionality but demonstrate the bi-directionality of subscriptions and notifications, along with illustrating that notifications can be pushed from nodes 12 that are higher in the M2M network hierarchy towards nodes 12 that are lower in the hierarchy. FIG. 9A for example illustrates a first application 16-1 that registers with a first SCL 14-1, where the application 16-1 in this example is a network application and the first SCL 14-1 is a network SCL, such as hosted at an M2M network server. Additionally, there are second and third applications 16-2 and 16-3, respectively, which are M2M device or gateway applications that register at a second SCL 14-2, which in this example operates as a GW SCL.

One sees that the registration of application 16-3 with the SCL 14-2 does not generate any outgoing inaugural registration notifications from the SCL 14-2 because there are no outstanding subscriptions when that registration occurs. The same is true with respect to the SCL 14-1 and the inaugural registration of the application 16-1 with the SCL 14-1. However, later in the signal flow of FIG. 9A, one sees a subscription request going from the SCL 14-2 to the SCL 14-1, triggered by application 16-3. The SCL 14-1 records corresponding subscription information and checks whether it has recorded any inaugural registrations that have not been reported to the SCL 14-2. Here, the inaugural registration of the application 16-1 with the SCL 14-1 has not been previously reported to the SCL 14-2, so a corresponding notification is sent from the SCL 14-1 to the SCL 14-2.

FIG. 9B shows that receipt of that notification at the SCL 14-2 prompts the SCL 14-2 to check whether it has any outstanding subscriptions for which the notification should be forwarded. Now, remembering that FIG. 9A illustrated the application 16-3 subscribing for such notifications to the SCL 14-2, the SCL 14-2 detects that outstanding subscription and determines from its notification tracking that is has not previously sent the application 16-3 an inaugural registration notification for the application 16-1 and one therefore sees that the SCL 14-2 provides the notification to the application 16-3. In turn, the application 16-3 provides permissions information for the application 16-1 with respect to a resource 42 owned or controlled by the application 16-3 and the SCL 14-2 updates a permissions database 40 based on receiving that permissions information. Of course, as previously noted, the SCL 14-2 may be delegated the authority to determine the permissions, or may submit the notification to the resource owner to obtain determined permissions information, which it then uses to update the permissions database 40 and/or to otherwise control access to the resource 42.

FIG. 9B also shows that the application 16-2 registers with the SCL 14-2. Assuming, as suggested by FIGS. 9A-9C, that the applications 16-2 and 16-3 are both resident on the node 12 hosting the SCL 14-2, whether the SCL 14-2 reports the inaugural registration by the application 16-2 to the application 16-3 is a configurable option in one or more embodiments contemplated herein. If such reporting is performed, the signaling will be internal to the SCL 14-2 and the application 16-3. To keep the diagrams uncluttered, such a notification is not explicitly illustrated.

FIG. 9C continues the example signaling flow by illustrating that the application 16-2 also subscribes to the SCL 14-2 for inaugural registration notifications. Now, because the SCL 14-2 previously detected or received notice of inaugural registrations by the application 16-1 and by the application 16-3, and because the registration and notification tracking information (e.g., the registration and subscription information 32 and 36 from FIG. 3) indicates that corresponding inaugural registration notifications have never been sent to the application 16-2 for those inaugural registrations, the SCL 14-2 sends such notifications to the application 16-2 and updates its tracking information to prevent repeat notifications to the application 16-2 for these same inaugural registrations.

FIG. 9C also shows the application 16-2 determining permissions information for one or both of the applications 16-3 and 16-1, with respect to a resource 42 that owned or controlled by the application 16-2, and returning that permissions information to the SCL 14-2, for updating a permissions database.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

1. A method at a first node in a Machine-to-Machine (M2M) network comprising:
receiving a subscription request from a second node in the M2M network, said subscription request requesting that inaugural registration notifications be sent from the first node to the second node;
storing subscription information corresponding to the subscription request;
detecting that a registration by an application with a Services Capability Layer (SCL) hosted by the first node is an inaugural registration;
sending, in response to said detection, an inaugural registration notification to the second node, according to the subscription information; and
recording the inaugural registration in registration information stored at the first node, for distinguishing a subsequent registration by the application with the SCL as a non-inaugural registration.

2. The method of claim 1, further comprising recording the inaugural registration notification in the subscription information, to prevent duplicate inaugural registration notifications from being sent to the second node for the same inaugural registration.

3. The method of claim 1, wherein sending the inaugural registration notification to the second node comprises sending one or more application-related identifiers, including at least one of: a name of the application, an identifier of the application, a uniform resource locator (URL) of the application, and an identifier of the SCL hosted the first node.

4. The method of claim 1, further comprising sending the inaugural registration notification to as many other nodes in the M2M network as have subscribed to the first node for inaugural registration notifications.

5. The method of claim 4, further comprising identifying the other nodes in the M2M network to which the first node should send inaugural registration notifications, based on recording corresponding subscription requests from each of the other nodes in the subscription information.

6. The method of claim 1, wherein the method includes maintaining state information at the first node, said state information comprising indicators indicating that inaugural registrations have been detected at the first node for given applications, and further comprising indicators indicating that inaugural registration notifications for a given application have been sent to given other nodes, in accordance with the subscription information stored for the given other nodes.

7. The method of claim 1, wherein the first node comprises one of: an M2M network server hosting a Network SCL (N-SCL); an M2M Gateway hosting a Gateway SCL (G-SCL); or an M2M device hosting a Device SCL (D-SCL).

8. A first node in a Machine-to-Machine (M2M) network, said first node comprising:
a communication interface configured to communicate with one or more other nodes in the M2M network, including a second node;
a processing circuit operatively associated with the communication interface and with a memory or other storage device, and configured to:
receive a subscription request from the second node, said subscription request requesting that inaugural registration notifications be sent from the first node to the second node;
store subscription information corresponding to the subscription request;
detect that a registration by an application with a Services Capability Layer (SCL) hosted by the first node is an inaugural registration;
send, in response to the detection of the inaugural registration, an inaugural registration notification to the second node, according to the subscription information; and
record the inaugural registration in registration information stored at the first node, for distinguishing a subsequent registration by the application with the SCL as a non-inaugural registration.

9. The first node of claim 8, wherein the processing circuit is configured to record the inaugural registration notification in the subscription information, to prevent duplicate inaugural registration notifications from being sent to the second node for the same inaugural registration.

10. The first node of claim 8, wherein the processing circuit is configured to send the inaugural registration notification to the second node by sending one or more application-related identifiers, including at least one of: a name of the application, an identifier of the application, a uniform resource locator (URL) of the application, and an identifier of the SCL hosted by the first node.

11. The first node of claim 8, wherein the processing circuit is configured to send the inaugural registration notification to as many other nodes in the M2M network as have subscribed to the first node for inaugural registration notifications.

12. The first node of claim 11, wherein the processing circuit is configured to identify the other nodes in the M2M network to which the first node should send inaugural registration notifications, based on recording corresponding subscription requests from each of the other nodes in the subscription information.

13. The first node of claim 8, wherein the processing circuit is configured to maintain state information at the first node, said state information comprising indicators indicating that inaugural registrations have been detected at the first node for given applications, and further comprising indicators indicating that inaugural registration notifications for a given application have been sent to given other nodes, in accordance with the subscription information stored for the given other nodes.

14. The first node of claim 8, wherein the first node comprises one of: an M2M network server hosting a Network SCL (N-SCL); an M2M Gateway hosting a Gateway SCL (G-SCL); or an M2M device hosting a Device SCL (D-SCL).

15. A method of automating access control in a Machine-to-Machine (M2M) network comprising:
sending a subscription request from a second node in the M2M network to a first node in the M2M network, requesting notification of inaugural registrations by M2M applications with a Services Capability Layer (SCL) hosted by the first node;
receiving at the second node an inaugural registration notification from the first node in accordance with the subscription request, for a first application that conducted an inaugural registration with the SCL hosted at the first node; and
determining permissions information at the second node for the first application with respect to a resource maintained at the second node by or for a second application that is registered at the second node, for controlling access to the resource by the first application.

16. The method of claim 15, wherein the application-related identifiers indicated in the inaugural registration notification includes one or more of the following items, a name of the first application, an identifier of the first application, a uniform resource locator (URL) of the first application, and an identifier of the SCL hosted at the first node, and wherein the permissions information is determined by an SCL of the second node and/or by the second application, based on the included indicators.

17. The method of claim 15, further comprising updating a permissions database stored at the second node according to the permissions information.

18. A second node configured for automating access control in a Machine-to-Machine (M2M) network comprising:
a communication interface configured for communicating with a first node in the M2M network; and
a processing circuit operatively associated with the communication interface and a memory or other storage device and configured to:
send a subscription request to the first node, requesting notification of inaugural registrations by M2M applications with a Services Capability Layer (SCL) hosted by the first node;
receive an inaugural registration notification from the first node in accordance with the subscription request, for a first application that conducted an inaugural registration with the SCL hosted at the first node; and
determine permissions information at the second node for the first application with respect to a resource maintained at the second node by or for a second application that is registered at the second node, for controlling access to the resource by the first application.

19. The second node of claim 18, wherein the application-related identifiers indicated in the inaugural registration notification includes one or more of the following items, a name of the first application, an identifier of the first application, a uniform resource locator (URL) of the first application, and an identifier of the SCL hosted at the first node, and wherein the permissions information is determined by an SCL of the second node and/or by the second application, based on the included indicators.

20. The second node of claim 18, wherein the processing circuit is configured to update a permissions database stored at the second node according to the permissions information.
